(19) United States
(12) Patent Application Publication
(10) Pub. No.: US 2007/0172299 A1
(43) Pub. Date: Jul. 26, 2007

(54) Mechanical pencil comprising a retractable lead guide

(76) Inventors: Rolion Franck, Belloy En France (FR); Duchesne Frederic, Saint Ouen L'Aumone (FR); Jeanne-Antide Bouveresse, Rueil Malmaison (FR)

Correspondence Address: JONES DAY, 222 EAST 41ST ST, NEW YORK, NY, 10017, US

(21) Appl. No.: 10/598,292

(22) PCT Filed: Feb. 22, 2005
(86) PCT No.: PCT/FR05/00412

§ 371 Date: Aug. 23, 2006

(30) Foreign Application Priority Data
Feb. 24, 2004 (FR) 0401844

(51) Int. Cl. B43K 21/22

(52) U.S. Cl. 401/92; 401/88

(57) ABSTRACT

A mechanical pencil that includes a body extending longitudinally along an axis X between a forward writing end and a rear end, and an endpiece situated at the forward end and a lead guide that can be retracted into the endpiece that includes a conduit for the passage of a lead. The mechanical pencil also includes a lead brake made of an elastically deformable material connected to the lead guide.

This application is a national stage application of PCT/FR-05/000412, filed on Feb. 22, 2005.

### FIELD OF INVENTION

The embodiments of the present invention relate to mechanical pencils comprising a retractable lead guide.

### BACKGROUND OF INVENTION

More particularly, the embodiments of the present invention relate to a mechanical pencil of the type comprising:
a body extending longitudinally along an axis X between a forward writing end and a rear end,
an endpiece situated at the forward end,
a lead guide that can be retracted into the endpiece and comprises a conduit for the passage of a lead and for its guidance in translational movement along the axis X, and
a lead brake made of an elastically deformable material connected to the lead guide, the lead brake comprising at least one region of friction between the lead and the lead brake to limit the movement of the lead in the lead guide, and at least one region of friction between the endpiece and the lead brake to limit the movement of the lead guide in the endpiece.

Document EP-A-1 125 763 describes an example of such a mechanical pencil.

In that document, and as shown in FIG. 9, the lead guide 5 comprises a conduit 6 formed integrally with a bell 21 wherein is placed a lead brake 13 made of rubber, i.e. an elastically deformable material. This lead brake 13 comprises a ring 20 inserted into the bell 21 and a crown 22 which projects from the bell 21 and extends radially outward, i.e. toward the endpiece 4. The part of the lead brake 13 that corresponds to the ring 20 exerts a circularly continuous and uniform pressure on the outer surface of the lead. The part of the lead brake 13 that corresponds to the crown 22 exerts a pressure that is also circularly continuous and uniform on the inside of the endpiece 4.

The embodiments of the present invention differ from this prior-art mechanical pencil notably in that each region of friction between the lead and the lead brake is shifted angularly about the axis X relative to each region of friction between the endpiece and the lead brake.

This disposition makes it simple to produce mechanical pencils of the type indicated above because the dimensional tolerances of the lead brake, and indeed those of the lead guide, can be less strict than in the mechanical pencils of the prior art.

In fact, for this type of mechanical pencil it is generally desirable for the lead to be gripped in the lead guide so that it does not fall out of the pencil when the lead feed chuck is opened. It is also desirable for the retractable lead guide to be gripped to prevent it from shaking freely inside the endpiece. However, the friction between the retractable lead guide and the endpiece must not be too great because a slight retraction of the lead guide is required when the lead is worn down in order to expose the forward end of the lead and allow writing to continue. Moreover it is preferable that the frictional force between the lead and the lead guide be less than the frictional force between the lead guide and the endpiece so that if too much lead has come out, the user can push it back into the pencil without causing the lead guide to retract.

These two types of frictional force must therefore be precisely controlled to achieve satisfactory user convenience. This type of fine-tuning can require that the dimensions of the lead brake be defined with very strict tolerances in order to give the right amount of force and contact area.

In a mechanical pencil in accordance with the embodiments of the present invention, the parts of the lead brake that apply frictional forces to the lead on the one hand and the endpiece on the other are shifted angularly. Fine-tuning of the frictional forces can therefore be effected on geometrically independent regions. Wider tolerances are therefore possible and a modification to one region of friction has limited influence on the other region of friction.

The prior art also includes, notably in document US-A-5 462 376, retractable lead guides wherein the friction between the lead and the lead guide and that between the lead guide and the endpiece is provided by fins formed integrally with the body of the lead guide and having structural elasticity in such a way as to press on one side against the lead and on the other against the inside of the endpiece. However, besides the geometrical complexity and the difficulty of fine tuning the frictional forces, the fact that these fins are necessarily made of a plastic material whose surface rigidity is greater than that of a rubber-type material means that there are limited contact surface areas and necessitates relatively high contact forces. Such a lead guide therefore demands low manufacturing tolerances and is generally more sensitive to graphite dust created by the passage of the lead, which can significantly modify the frictional forces.

When the embodiments of the present invention is put into practice, recourse may optionally also be had to any of the following provisions:
the lead brake, considered perpendicularly to the axis X, is of an elongate shape, regions of endpiece-lead brake friction being formed at each end of the elongate shape;
the lead brake is of an annular shape;
the lead brake is held on the lead guide between two shoulders;
the conduit of the lead guide comprises at least one opening through which the lead brake acts on the lead, in a region of lead-lead guide friction;
two diametrically opposed regions of endpiece-lead brake friction are provided, and two diametrically opposed regions of lead-lead brake friction are provided, the regions of friction between the endpiece and the lead brake being angularly shifted through about 90 degrees relative to the regions of friction between the lead and the lead brake;
the lead brake is torus-shaped before being fitted on the lead guide;
the lead guide and the lead brake form a one-piece component composed of at least two materials;
the lead guide has at least one portion made of a synthetic resin on which the lead brake is overmolded, preferably by a two-shot injection molding process, in an elastomer; and
the lead guide forms the forward end of a cartridge comprising a lead feed mechanism and mounted removably inside the body.

Other aspects, objects and advantages of the present invention will become apparent from a reading of the description of one of these embodiments.

### BRIEF DESCRIPTION OF THE DRAWINGS

FIG. 1 is a schematic longitudinal section through a body of one example of an embodiment of a mechanical pencil according to the embodiment of the present invention;

FIG. 2 is a schematic view of the endpiece of the mechanical pencil of FIG. 1;

FIG. 3 is a schematic perspective view of a lead guide designed to be mounted in an endpiece such as that shown in FIG. 2;

FIG. 4 shows, seen from the top, the lead guide of FIG. 3;

FIG. 5 is a schematic transverse section through the lead guide shown in FIG. 4;

FIG. 6 is a schematic partial section through the lead guide shown in FIG. 3-5 mounted in an endpiece such as that of FIG. 2

FIG. 7 corresponds to an enlargement of FIG. 6;

FIG. 8 is a schematic view of a lead cartridge designed to be housed in a mechanical pencil in another embodiment of the present invention; and

FIG. 9 is a schematic section, in a view similar to that of FIG. 2, of an endpiece, a lead guide and a lead brake of a mechanical pencil of the prior art.

In the various figures, identical reference denote identical or similar parts.

### DETAILED DESCRIPTION OF DRAWINGS

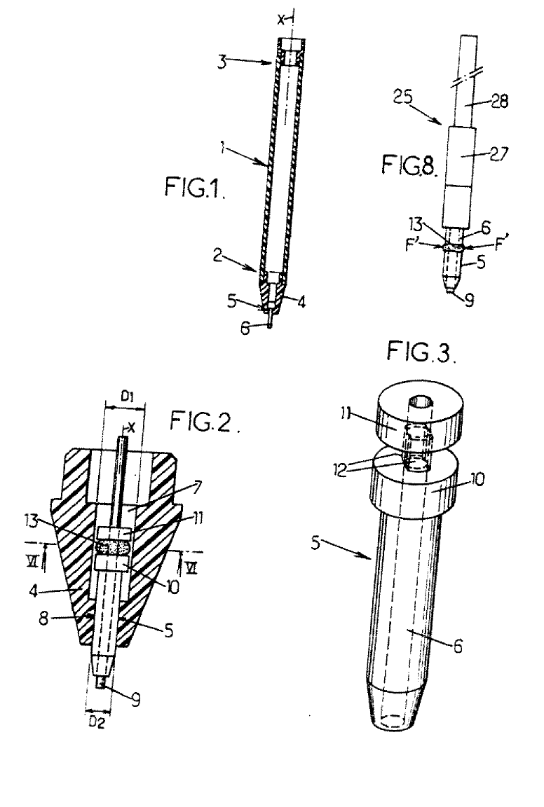

An example of a mechanical pencil according to the embodiment of the present invention is shown in FIG. 1. It has a cylindrical body 1 extending longitudinally along an axis X. This body 1 has a forward end 1 and a rear end 3. An endpiece 4 is mounted at the forward end 2. This endpiece 4 comprises a lead guide 5. This lead guide 5 comprises a conduit 6 designed to guide a lead translationally along the axis X and protect it as it emerges from the endpiece 4.

Hereinafter, the mechanical pencil according to the embodiment of the present invention will not be described in detail except as relate to its endpiece 4 and its lead guide 5 because the rest of the lead-advancing mechanism (which is not shown), in the mechanical pencil, can be of any type known to those skilled in the art.

As shown in FIG. 2, the endpiece 4 is essentially in the shape of a frustum of a cone. It has a first cylindrical cavity 7 of revolution about the axis X. This first cavity 7 has an inside diameter D₁ and continues toward the tip of the endpiece 4 through a second cylindrical cavity 8 of revolution about the axis X and of diameter D₂.

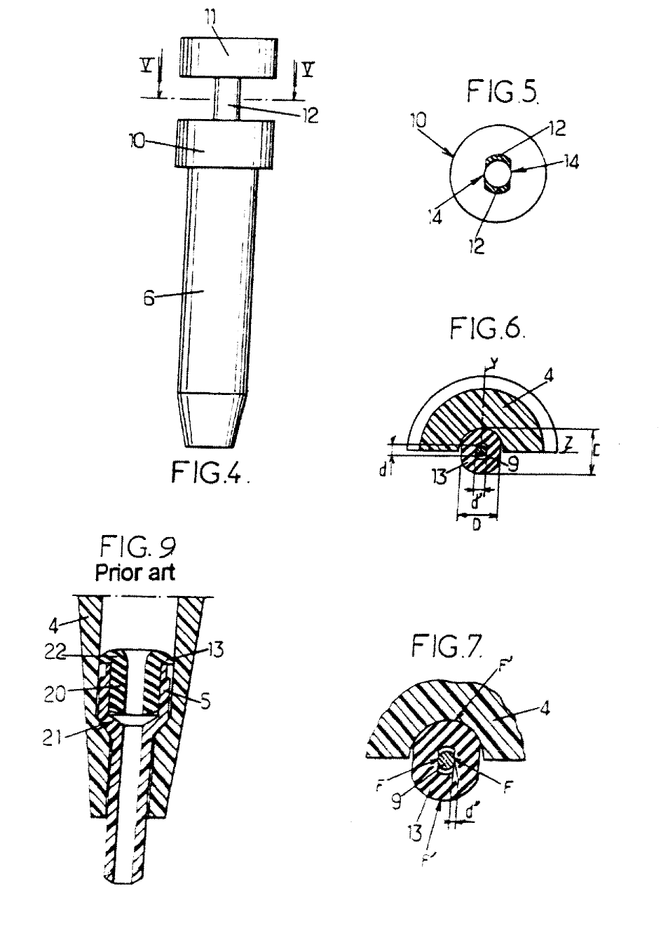

As shown in FIGS. 2-4, the conduit 6 of the lead guide 5 has the shape of cylinder of revolution about the axis X with an outside diameter marginally smaller than the diameter D₂ of the second cavity 8. The outside diameter of the conduit 6 and the diameter D₂ of the second cavity are such that the lead guide 5 can be moved in a guided manner but without effort, through the endpiece 4.

The conduit 6 has an inside diameter such that a lead 9 can pass along it parallel to the axis X without effort.

The lead guide 5 is made from materials having a certain rigidity in such a way as to have stable geometrical dimensions that allow it to slide through the endpiece 4 without sticking, and allow the lead 9 to be guided and held in position as far as its forward end. The lead guide 5 may be made of a plastic such as POM, ABS or SAN, but it may be made wholly or partly of metal.

The lead guide 5 has a first shoulder 10 to keep this lead guide 5 in the second cavity 8. A second shoulder 11 is connected to the first shoulder 10 by two bridges 12. The first 10 and second 11 shoulders have the same diameter. This diameter is such that the first 10 and second 11 shoulders slide without friction in the second cavity 8.

The first 10 and second 11 shoulders are cylinders of revolution about the axis X. The distance between the first 10 and second 11 shoulders is less than the difference between the inside diameter of the conduit 6 and the outside diameter of the first 10 and second 111 shoulders. Thus, when an initially toroidal lead brake 13 is inserted between the first 10 and second 11 shoulders, if its diameter corresponds to the distance between these shoulders it will necessarily project radially beyond the latter and adopt an elongate form.

The lead brake 13 is made of an elastomer, but could also be made of rubber or any other elastically deformable material to enable it to conform to the surfaces with which it must create a region of friction. It will be observed that the toric lead brake 13 is very easy to produce and can even be a standard part. However, the lead brake 13 may have a shape other than that of a torus. It may be a ring that is radially flat and/or flat in its thickness.

As shown in FIG. 5, each bridge 12 corresponds to a portion of cylinder whose inside diameter is equal to the inside diameter of the conduit 6 and whose outside diameter is 1.2 to 1.5 times greater than this inside diameter. The two bridges 12 are diametrically opposed and are spaced apart in such a way as to leave two openings 14 that are also diametrically opposed.

As shown in FIG. 6, when a toric lead brake 13 is inserted between the first 10 and second 11 shoulders it adopts an elongate shape because of the radial thickness of the bridges 12.

The inside diameter of the lead brake 13 is approximately equal to the outside diameter of the lead 9 and to the inside diameter of the conduit 6. The outside diameter of the lead brake 13 is between the outside diameter of the first 10 and second 111 shoulders and the inside diameter D₂ of the second cavity 8. Thus, when the lead brake 13 is placed between the first 10 and second 11 shoulders it is deformed because of the radial thickness of the bridges 12.

As shown in FIG. 7, the lead brake 13 thus applies pressure, along an axis Y, to the inside face of the second cavity 8. Similarly, through the openings 14, the lead brake 13 applies pressure along an axis 7 to the lead 9.

The distance D defining the dimension of the lead brake 13 along the axis Z is such that there is no contact, along the corresponding direction, between the lead brake 13 and the endpiece 4. The distance D′ corresponding to the dimension of the lead brake 13 along the axis Y, when the latter is in place on the lead guide 5, is such that the lead brake 13 is in contact with the endpiece 4. However, the lead brake 13 possesses a diameter, when not mounted on the lead guide 5, which is smaller than the inside diameter D₂ of the second cavity 8.

The result is that a region of friction F′ is created between the endpiece 4 and the lead brake 13.

The diameter d corresponds to the diameter of the lead 9. This diameter d is greater than the distance d′ which would separate the regions of the lead brake 13 separating the openings 14 along the Z axis.

Thus, the difference d′ between the diameter d of the lead 9 and the distance d′ is such that the lead 9 projects through the openings 14, so defining a region of friction F between the lead 9 and the lead brake 13.

The function forces acting between the endpiece 4 and the lead brake 13 in the regions of friction F, are less than the friction forces acting between the lead 9 and the lead brake 13 in the regions of friction F.

There are thus created two diametrically opposed regions of friction F′ between the endpiece and the lead brake, and two regions of friction between the lead and the lead brake F, also diametrically opposed but shifted angularly through 90° relative to the regions of friction F′ between the endpiece and the lead brake. This disposition of the regions of friction ensures symmetry not only between the braking forces acting on the lead but also between the braking forces acting on the lead guide 5 in the endpiece 4, while also in a sense separating from each other the different regions of the lead brake that generate the different frictional forces and also limiting the complexity of the lead guide 5 and lead brake 13.

In another embodiment, shown in FIG. 8, the lead guide 5 can be an integral part of a lead cartridge 25. The lead cartridge 25 comprises, besides the lead guide A, a sleeve 27 containing a lead feed mechanism, such as a known mechanism comprising a chuck whose gripping head cooperate with a ring, and a tube 28 extending up to the rear end of the mechanical pencil, forming a holder for the leads and serving to transmit to the feed mechanism the action of the user pressing on a button (not shown) situated at the rear end of the mechanical pencil. This cartridge 25 is mounted removably inside a mechanical pencil as shown in FIG. 1 which comprises a body 1 and an endpiece 4. As in the previous embodiment, the lead guide 5 comprises a lead brake 13 made of an elastomer. In this embodiment the lead brake 13 is molded directly onto the lead guide 5, which is made of plastic. The overmolding of the lead brake 13 is preferably done by a two-shot injection molding process, that is, the lead guide 5 is made by an initial injection of thermoplastic material into a mold comprising a core to form the conduit 6, followed by injection of the elastomer into this mold without withdrawing the core in order to form the lead brake 13.

As in the previous embodiment, the lead brake 13 is of an elongate shape, its diametrically opposite ends projecting from the lead guide 5 and forming the regions of friction F′ between the endpiece and the lead brake. There are also openings (not visible in FIG. 8) through the lead guide 5 so that the lead brake 13 can form part of the wall of the conduit 6 and contact the lead 9 to resist its movement.

The regions of friction F′ between the endpiece and the lead brake can resist the retraction of the lead guide 5 if the entire cartridge 25 is moveable over a certain distance inside the body of the mechanical pencil, or if the lead guide 5 is able to move longitudinally a certain distance relative to the sleeve 27. However, the regions of friction F′ between the endpiece and the lead brake also mean that the cartridge can be immobilized in the body of the mechanical pencil if there is a certain clearance between the rear end of the lead holder tube 28 and the control button acting on this end. This will prevent clicking noises of the cartridge 25 inside the mechanical pencil.

These embodiments are of course in no way restrictive and their various features can be combined. For example, in the case of the first embodiment, the endpiece 4 and the body 1 can be a one-piece component. Again in the case of this first embodiment, the lead guide 5 and the lead brake 13 can be a one-piece component formed from two materials, one a thermoplastic and the other an elastomer, by twin-shot injection molding.

1.-10. (canceled)

11. A mechanical pencil comprising
a body extending longitudinally along an axis X between a forward writing end and a rear end,
an endpiece situated at the forward end;
a lead guide that can be retracted into said endpiece and comprising a conduit for the passage of a lead and for its guidance in translational movement along said axis X; and
a lead brake made of an elastically deformable material connected to said lead guide, said lead brake comprising at least one re-ion of friction between the lead and said lead brake to limit the movement of the lead in said lead guide, and at least one region of friction between said endpiece and said lead brake to limit the movement of said lead guide in the endpiece,
wherein each region of friction between the lead and said lead brake is shifted angularly about the axis X relative to each region of friction between said endpiece and said lead brake.

12. The mechanical pencil according to claim 11, wherein said brake, considered perpendicularly to the axis X, includes an elongate shape wherein regions of said endpiece-lead brake friction being formed at each end of the elongate shape.

13. The mechanical pencil according to claim 11, wherein said lead brake includes an annular shape.

14. The mechanical pencil according to claim 11 wherein said lead brake is positioned on said lead guide between two shoulders.

15. The mechanical pencil according to claim 11, wherein the conduit of said lead guide comprises at least one opening through which said lead brake acts on the lead, in a region of lead-lead-guide friction.

16. The mechanical pencil according to claim 11, wherein two diametrically opposed regions of endpiece-lead brake friction are provided, and wherein two diametrically opposed regions of lead-lead brake friction are provided, the regions of lead-lead brake friction being angularly shifted about 90 degrees relative to the regions of lead-lead brake friction.

17. The mechanical pencil according to claim 11, wherein said lead brake includes a torus-shape before being fitted on said lead guide.

18. The mechanical pencil according to claim 11, wherein said lead guide and said lead brake form a one-piece component composed of at least two materials.

19. The mechanical pencil according to claim 11, wherein said lead guide includes at least one portion made of a synthetic resin on which said lead brake is overmolded in an elastomer.

20. The mechanical pencil according to claim 11, wherein said lead guide forms the forward end of a cartridge comprising a lead feed mechanism and mounted removably inside said body.

21. A mechanical pencil comprising:
a body extending longitudinally along an axis X between a forward writing end and a rear end;
an endpiece situated at the forward end;
a lead guide that can be retracted into said endpiece and comprising a conduit for the passage of a lead and for its guidance in translational movement along said axis X; and
a lead brake made of an elastically deformable material connected to said lead guide, said lead brake comprising at least one region of friction between the lead and said lead brake to limit the movement of the lead in said lead guide, and at least one region of friction between said endpiece and said lead brake to limit the movement of said lead guide in the endpiece,
wherein each region of friction between the lead and said lead brake is shifted angularly about the axis X relative to each region of friction between said endpiece and said lead brake, and
wherein said lead brake is positioned on said lead guide between two shoulders.

22. A mechanical pencil comprising:
a body extending longitudinally along an axis X between a forward writing end and a rear end;
an endpiece situated at the forward end;
a lead guide that can be retracted into said endpiece and comprising a conduit for the passage of a lead and for its guidance in translational movement along said axis X; and
a lead brake made of an elastically deformable material connected to said lead guide, said lead brake comprising at least one region of friction between the lead and said lead brake to limit the movement of the lead in said lead guide, and at least one region of friction between said endpiece and said lead brake to limit the movement of said lead guide in the endpiece,
wherein each region of friction between the lead and said lead brake is shifted angularly about the axis X relative to each region of friction between said endpiece and said lead brake, and
wherein said lead guide and the said lead brake form a one-piece component composed of at least two materials.
